(19) United States
(12) Patent Application Publication
(10) Pub. No.: US 2023/0400138 A1
(43) Pub. Date: Dec. 14, 2023

(54) DEVICE FOR WINTERIZING PLUMBING

(71) Applicant: Todd Ian Harbert, Columbus, OH (US)

(72) Inventor: Todd Ian Harbert, Columbus, OH (US)

(21) Appl. No.: 17/806,603

(22) Filed: Jun. 13, 2022

(51) Int. Cl. F16L 55/11; E04H 4/12

(52) U.S. Cl. CPC F16L 55/1108; E04H 4/12

(57) ABSTRACT

A device for sealing a pipe fitting includes an outer plug having a first diameter with male threading and a second diameter with female threading and an inner plug having a first diameter with male threading, a second diameter, and a face, perpendicular to its first diameter and its second diameter, sealing a first end of the inner plug. The first diameter of the inner plug threadedly fastens into the second diameter of the outer plug.

### BACKGROUND OF THE INVENTION

The present invention relates to plumbing and, more particularly, to a device for winterizing plumbing.

Winterizing plumbing, such as swimming pools/spas typically requires draining and clearing water from plumbing fittings. Air is then pushed through the plumbing to clear it of water. When underwater plumbing cannot be sealed off and drained, it becomes very difficult to clear the plumbing of water. Attempting to winterize plumbing in these situations can cause damage to automatic pool covers and compromise the pool's structure.

Currently, plugs are used to seal off individual fittings. However, the only winterization plugs available for use in underwater applications are check valves. These valves cannot be manually closed.

When there are multiple fittings, valves should be isolated to best clear out all of the water. Present check valves do not grant this capability. Thus, there is no way to isolate a desired plumbing line to winterize it.

As can be seen, there is a need for a device that enables a user to isolate plumbing lines when winterizing pools or spas.

### SUMMARY OF THE INVENTION

In one aspect of the present invention, a device for sealing a pipe fitting comprises an outer plug having a first diameter with male threading and a second diameter with female threading, and an inner plug having a first diameter with male threading, a second diameter, and a face, perpendicular to its first diameter and its second diameter, sealing a first end of the inner plug, wherein the first diameter of the inner plug threadedly fastens into the second diameter of the outer plug.

In another aspect of the present invention, a method of winterizing plumbing comprises threadedly fastening an outer plug into a plumbing fitting, threadedly fastening an inner plug into the outer plug, adjusting the inner plug within the outer plug as to expose apertures on a side of the inner plug, removing water in the plumbing by forcing water through the apertures of the inner plug, and tightening the inner plug within the outer plug to seal the plumbing fitting.

These and other features, aspects and advantages of the present invention will become better understood with reference to the following drawings, description, and claims.

### BRIEF DESCRIPTION OF THE DRAWINGS

FIG. 1 is a perspective view of an inner plug and an outer plug according to an embodiment of the present invention shown in use;

FIG. 2 is a perspective view thereof;

FIG. 3 is an exploded view thereof;

FIG. 4 is a section view taken on line 4-4 of FIG. 2;

FIG. 5 is a section view taken on line 5-5 of FIG. 4; and

FIG. 6 is detail view of the inner plug being removed from the outer plug.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims with reference to the drawings.

A general overview of the various features of the invention will be provided, with a detailed description following. Broadly, an embodiment of the present invention provides a device to seal a plumbing or a plumbing fitting. The device may be used for winterization of a swimming pool or spa.

In some embodiments of the present invention, the device may be threaded into a plumbing fitting, such as in the wall of a pool. The device may be manually opened or closed to seal desired fittings. After the device is threaded onto a fitting, air may be blown through the plumbing to remove and blow out water. By sealing desired fittings, water may be removed more effectively and efficiently from specified plumbing lines.

A user may seal or plug a fitting or plumbing line, isolating and trapping air and/or water in the plumbing line. Because this device may be manually opened/closed, a user may readily and efficiently isolate desired fittings or plumbing lines. These plumbing lines may then be easily winterized.

In some embodiments of the present invention, the device may comprise an outer plug and an inner plug. The outer plug may thread into a pool wall or a plumbing fitting. The inner plug may be loosened or tightened within the outer plug to form a seal.

The outer plug may have a first diameter (or an outer diameter) and a second diameter (or an inner diameter). The outer plug may have male threading on its first diameter and female threading on its second diameter. The first diameter may be its exterior and the second diameter may be its interior. The outer plug may have a face perpendicular to its first diameter and its second diameter. The face may have a perimeter with eight sides. The octagonal face may be configured to tighten or loosen the outer plug with a wrench or a ratchet.

The inner plug may comprise a first diameter (or an outer diameter) and a second diameter (or an inner diameter). The inner plug may have male threading on its first diameter. The first diameter may be its exterior and the second diameter may be its interior. The first diameter of the inner plug may threadedly fasten to the second diameter of the outer plug.

The inner plug may further comprise a face on a first end, perpendicular to its first and its second diameter. The face may seal the interior of the inner plug on the first end. A second end of the inner plug may expose the inner plug's second diameter, as the inner plug may be hollow. The face of the inner plug may have protruding nipples configured to receive or accommodate a flat head of a screwdriver. Alternatively, the face may have a slot configured to receive or accommodate a screwdriver. The slot may fit a Phillips™ or flat head screwdriver. The screwdriver may be used to tighten or loosen the inner plug within the outer plug. The inner plug may be approximately one inch in length.

The inner plug may further comprise apertures or breathing ports on its side. The inner plug may have one or two of said apertures. The apertures may extend through the inner plug's first diameter and to the inner plug's second diameter, providing a route for fluid to escape from the inner plug's interior.

Some embodiments of the present invention may include gaskets or O-rings at a junction between the inner plug and outer plug for sealing the device. A gasket or O-ring may also be included between the outer plug and the wall.

In some embodiments of the present invention, when the device is installed onto plumbing for blowing out a pipe or conduit of a pool or spa for winterization, the inner plug of the device may be partially inserted into the outer plug, exposing the apertures or breathing ports. Air pressure may be applied to the plumbing, forcing water within the plumbing to escape via the aperture. Once the water is blown out, the inner plug may be threaded tightly into the outer plug to seal the plumbing and prevent water from re-entering.

Multiple devices may be utilized when blowing out a pool or spa or any plumbing device. Each plug may be operated manually, enabling a user to isolate each pipe or fitting individually.

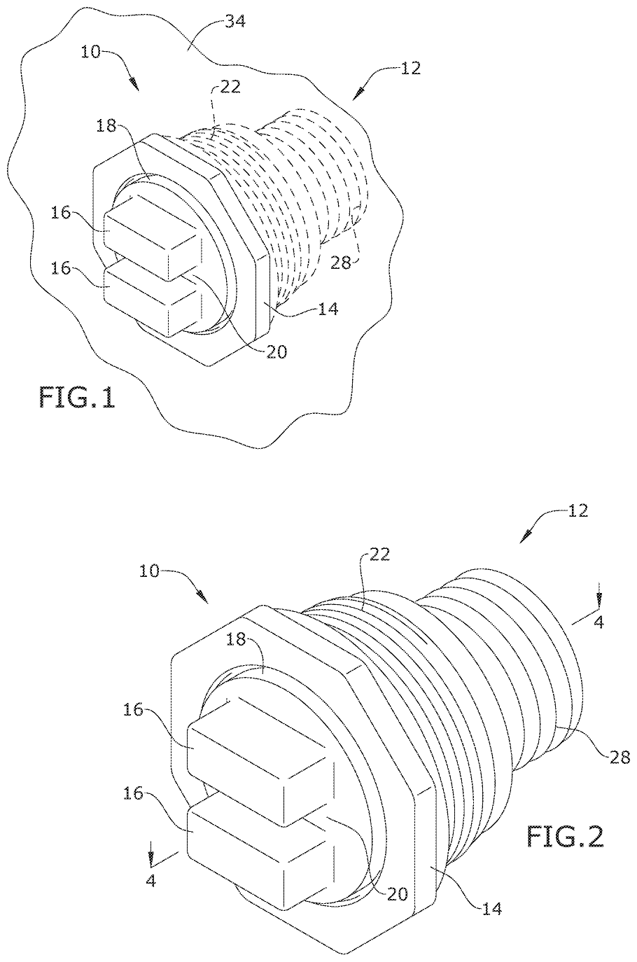

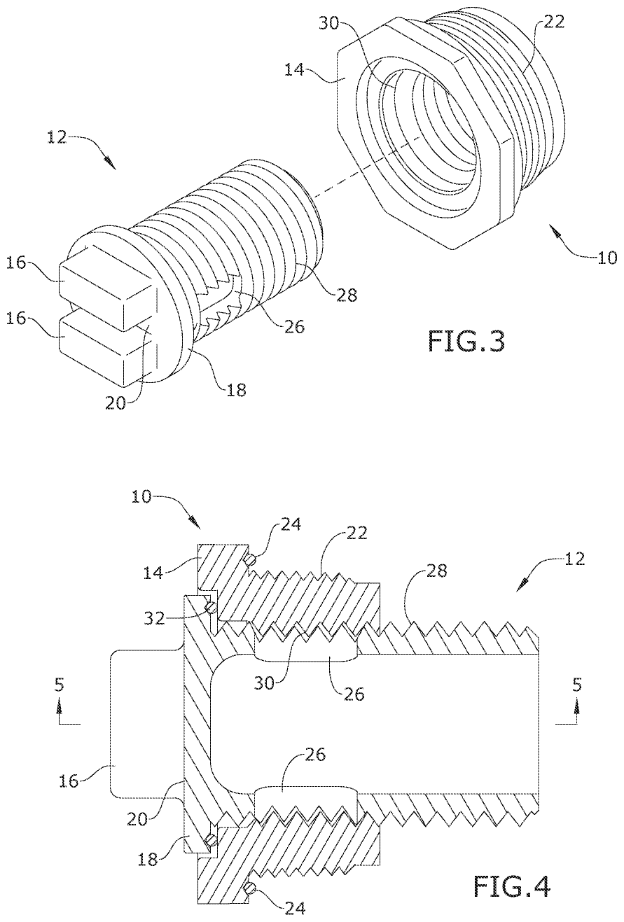

Referring now to FIGS. 1-6, a plug device is shown according to an embodiment of the present invention. The present invention may comprise an inner plug 12 and an outer plug 10 (best seen in FIG. 3). Inner plug male threads 28 are configured to fit into outer plug female threads 30 and threadedly fasten the inner plug 12 into the outer plug 10. An outer plug face 14 has eight sides on its perimeter, enabling a user to manipulate the outer plug face 14 with a wrench or ratchet. Protruding nipples 16 abut from an inner plug face 18, enabling a user to manipulate the inner plug 12 by inserting a screwdriver into an open slot 20.

Outer plug male threads 22 fasten the present invention to a wall 34. A large O-ring 24 is situated between the outer plug 10 and the wall 34. A small O-ring 32 is situated between the inner plug face 18 and the outer plug 10.

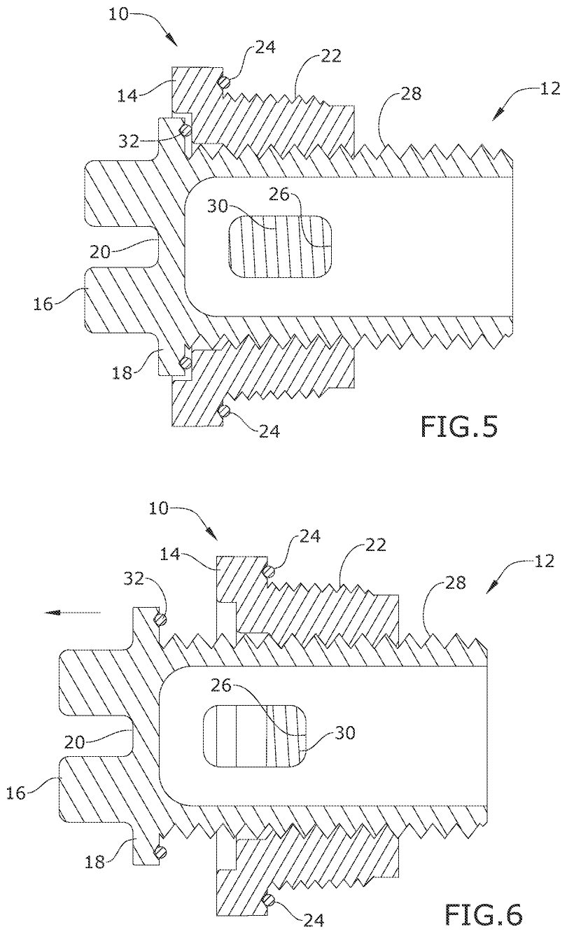

When fastened to the wall 34, the inner plug 12 may be adjusted to expose an aperture 26, as best seen in FIG. 6. When exposed, water or fluid within a plumbing may be removed from the pipe fitting. When the inner plug 12 is tightened into the outer plug 10, a seal may be formed, preventing water or fluid from leaving the plumbing.

It should be understood, of course, that the foregoing relates to exemplary embodiments of the invention and that modifications may be made without departing from the spirit and scope of the invention as set forth in the following claims.

What is claimed is:

1. A device for sealing a pipe fitting comprising:
an outer plug having a first diameter with male threading and a second diameter with female threading; and
an inner plug having a first diameter with male threading, a second diameter, and a face, perpendicular to its first diameter and its second diameter, sealing a first end of the inner plug;
wherein the first diameter of the inner plug threadedly fastens into the second diameter of the outer plug.

2. The device of claim 1, wherein the face has two protruding nipples configured to receive a flat head of a screwdriver.

3. The device of claim 1, wherein the face has a slot configured to receive a a screwdriver.

4. The device of claim 1, wherein the inner plug further comprises an aperture on its side, extending through the first diameter and to the second diameter.

5. The device of claim 1, wherein the outer plug further comprises a face perpendicular to its first diameter and its second diameter, wherein said face has eight sides on its perimeter.

6. A method of winterizing plumbing comprising:
threadedly fastening an outer plug into a plumbing fitting;
threadedly fastening an inner plug into the outer plug;
adjusting the inner plug within the outer plug as to expose apertures on a side of the inner plug;
removing water in the plumbing by forcing water through the apertures of the inner plug; and
tightening the inner plug within the outer plug to seal the plumbing fitting.
